(19) United States
(12) Patent Application Publication
(10) Pub. No.: US 2018/0297159 A1
(43) Pub. Date: Oct. 18, 2018

(54) WORK HOLDING FIXTURE

(71) Applicant: Jonathan Diaz, North Chesterfield, VA (US)

(72) Inventor: Jonathan Diaz, North Chesterfield, VA (US)

(21) Appl. No.: 15/951,809

(22) Filed: Apr. 12, 2018

Related U.S. Application Data
(60) Provisional application No. 62/484,938, filed on Apr. 13, 2017.

(51) Int. Cl. B23Q 3/06

(52) U.S. Cl. CPC B23Q 3/06; B23Q 2703/02

(57) ABSTRACT

A work holding fixture manufactured out of one single block of metal, usually aluminum. The size of the block may vary according to the size and weight of the workpiece to be held. A dovetail shape cut with female characteristics is machined on the top face of the fixture, the dimension of this dovetail shape cut also vary according to the size of the workpiece. Two more cuts are added to the fixture to make the fixture somewhat flexible. One of these cuts is machined on the center of the fixture and perpendicular to the dovetail shape cut and the other cut parallel to the dovetail shape cut. To hold the workpiece in the work holding fixture: The same size dovetail shape must be machined on one of the faces of the blank. The dovetail shape cut must have the same dimension as the dovetail shape cut on the work holding fixture but have male characteristics. Once the dovetail shape cut is machined the blank slides easily in the work holding fixture. The blank is tightened with 10-32 screws. At this point the blank is ready to be applied to the desired manufacturing process.

### RELATED APPLICATIONS

This application claims priority from, and incorporates by reference, U.S. provisional application Ser. No. 62/484,938, filed Apr. 13, 2017.

### FIELD OF THE INVENTION

The invention relates to a work holding fixture including a dovetail shape cut with female characteristics.

### BACKGROUND OF THE INVENTION

Work holding fixtures, such as vices, vacuum plates, and clamps, of all kinds, are implemented in various shapes and sizes. These work holding fixtures are used in the manufacturing industry to hold blocks made from various materials such as metals, plastics and in many cases wood. These blocks undergo various manufacturing processes, such as machining, to produce components for equipment and machinery of all sorts. The work holding fixture selection used in a particular situation depends upon the processes and shapes of components to be manufactured. Many of these components are very complex in shape and tolerance which makes them very hard to produce with conventional work holding devices, fixtures and machinery. This adds costs and inefficiencies to the manufacturing process.

### BRIEF SUMMARY OF THE INVENTION

An object of the invention is to provide work holding fixtures that improve the efficiency of manufacturing while being inexpensive by providing a way to hold blocks of material so that those blocks can be manufactured in a very efficient, cost-effective manner. One way to achieve this object of the invention is to make a fixture out of a single block of soft metal (e.g., aluminum) and then machine a dovetail shape cut on one of the faces of the block along with two more cuts, one parallel to the dovetail feature and one perpendicular. These two last cuts mentioned make the block just flexible enough to clamp and hold the workpiece and maintain rigidity.

The object is furthered by adding 10-32 size tapped holes on one side of the block and thru holes with c-bores opposite to the 10-32 tapped holes. The c-bores house 10-32 screws used to provide the clamping force to hold the working piece.

Another object of the invention is to provide a work holding fixture including a single blank of metal having a plurality of faces, and a dovetail shape cut with female characteristics is located on one of the plurality of faces. The dovetail shape cut may be located on a top face of the single blank of metal. A cut on the center of the single metal blank and perpendicular to the dovetail shape cut also may be included in the fixture. The cut on the center of the single metal blank may be ⅛ of an inch wide. A second cut on a side of the single metal blank also may be included in the fixture. The second cut may be 5/32 of an inch wide. A set of drilled and tapped holes for a plurality of screws also may be included in the fixture. The plurality of screws may number between 10-32 screws. A second set of drilled and tapped holes for a plurality of screws also may be included in the fixture. The plurality of screws for the second set may number between 10-32 screws. Two bores on each side of the fixture to hold the fixture using screws to attach a sub-plate which is clamped to a trunnion may be included in the fixture. The two bores may be ¼-20 c bores and the screws may be ¼-20 socket head screws. The fixture also may include precision blind holes on a bottom face of the fixture, and two dowel pins are installed in the precision blind holes. The precision blind holes on a bottom face of the fixture may be ¼ inch holes. The single blank of metal may be a single blank of a soft metal such as aluminum.

Another object of the invention is to provide a work holding fixture including a single blank of metal having a plurality of faces including a top face, a bottom face, and four side faces, a dovetail shape cut with female characteristics is located on the top face, a cut on the center of the single metal blank and perpendicular to the dovetail shape cut that is ⅛ of an inch wide, a second cut on a side of the single metal blank that is 5/32 of an inch wide, a set of drilled and tapped holes for 10-32 screws, a second set of drilled and tapped holes for 10-32 screws, two ¼-20 c bores on each side of the fixture to hold the fixture using ¼-20 socket head screws to a sub-plate which is clamped to a trunnion, ¼ inch precision blind holes on a bottom face of the fixture, and two dowel pins are in the precision blind holes. The single blank of metal may be a single blank of a soft metal such as aluminum.

### BRIEF DESCRIPTION OF THE DRAWINGS

The invention will be described in detail with reference to the following drawings in which like reference numerals refer to like elements wherein:

FIG. 1 Illustrates an exploded isometric view of the work holding fixture as an assembly according to an exemplary embodiment of the invention;

FIG. 2 Illustrates an exploded right side view of the work holding fixture as an assembly according the exemplary embodiment of the invention;

FIG. 3 Illustrates a front view of the work holding fixture according to the exemplary embodiment of the invention;

FIG. 4 Illustrates a top view of the work holding fixture according to the exemplary embodiment of the invention;

FIG. 5 Illustrates a right side view of the work holding fixture according to the exemplary embodiment of the invention; and

FIG. 6 Illustrates an isometric view of the work holding fixture as an assembly clamping an exemplary component.

### DETAILED DESCRIPTION OF THE INVENTION

A work holding fixture manufactured out of one single block of metal. The single block of metal is advantageously a soft metal such as aluminum. The size of the block may vary according to the size and weight of the workpiece to be held. A dovetail shape cut with female characteristics is machined on the top face of the fixture, the dimension of this dovetail shape cut also varies according to the size of the workpiece. Two more cuts are added to the fixture to improve the flexibility of the fixture. One of these cuts is machined on the center of the fixture and perpendicular to the dovetail shape cut and the other cut parallel to the dovetail shape cut. The perpendicular cut may, for example, be ⅛ inch wide and the parallel cut may, for example, be 5/32 inch wide. To hold the workpiece in the work holding fixture, the same size dovetail shape must be machined on one of the faces of the blank. The dovetail shape cut must have the same dimension as the dovetail shape cut on the work holding fixture but have male characteristics. Once the dovetail shape cut is machined the blank slides easily in the work holding fixture. The blank may be tighten with screws, for example 10-32 screws. At this point the blank is ready to undergo manufacturing processes.

Different industries such as medical, semiconductor, aerospace, auto, and many more require a variety of components. Every single one of these components starts as a blank. This blank can be made of metal, plastic, wood, or other suitable materials, and may be various grades and hardnesses. These components vary in shape and size and the components often require very small tolerances. The main purpose of the work holding fixture is to be able to hold components with very complex shapes and/or very small tolerances. In addition, the fixture enables the application of manufacturing processes on five sides of the components regardless of the manufacturing process. None of these components are functional until they are completed to blue print specifications. Accordingly, the terms “blank” or “workpiece” to refer to the component.

One set of holes are drilled and tapped for 10-32 socket head screws on the face of the block opposite to the ⅛ parallel cut. On these set of tapped holes 10-32 helical threaded inserts are installed for durability this set of 10-32 holes are for screws that will apply a clamping force, this is the clamping force that in conjunction with the dovetail feature (cut) keeps the working piece secured.

A second set of holes is drilled and tapped for 10-32 socket head screws on the same face where the ⅛ parallel cut was machined. This set of 10-32 tapped holes has no helical inserts. The purpose of this set of 10-32 screws is for unclamping the working piece when the work is completed by adding an opening action to the fixture.

One set of two ¼-20 c, bores is machined on each side of the fixture to hold the fixture using ¼-20 socket head screws to a sub-plate or rotating table better known as trunnion.

Two ¼ precision blind holes are machined on the bottom face of the fixture. Two dowel pins are installed in to these holes. These dowel pins allow the operator to locate the fixture in a very precise way when needed.

To hold the blank in the work holding fixture: The same size dovetail shape must be machined on one of the faces of the blank. The dovetail shape cut must have the same dimension as the dovetail shape cut on the work holding fixture but have male characteristics. Once the dovetail shape cut is machined the blank slides easily in the work holding fixture. The blank is tightened with the first set of 10-32 screws. At this point the blank is ready to be applied to the desired manufacturing process.

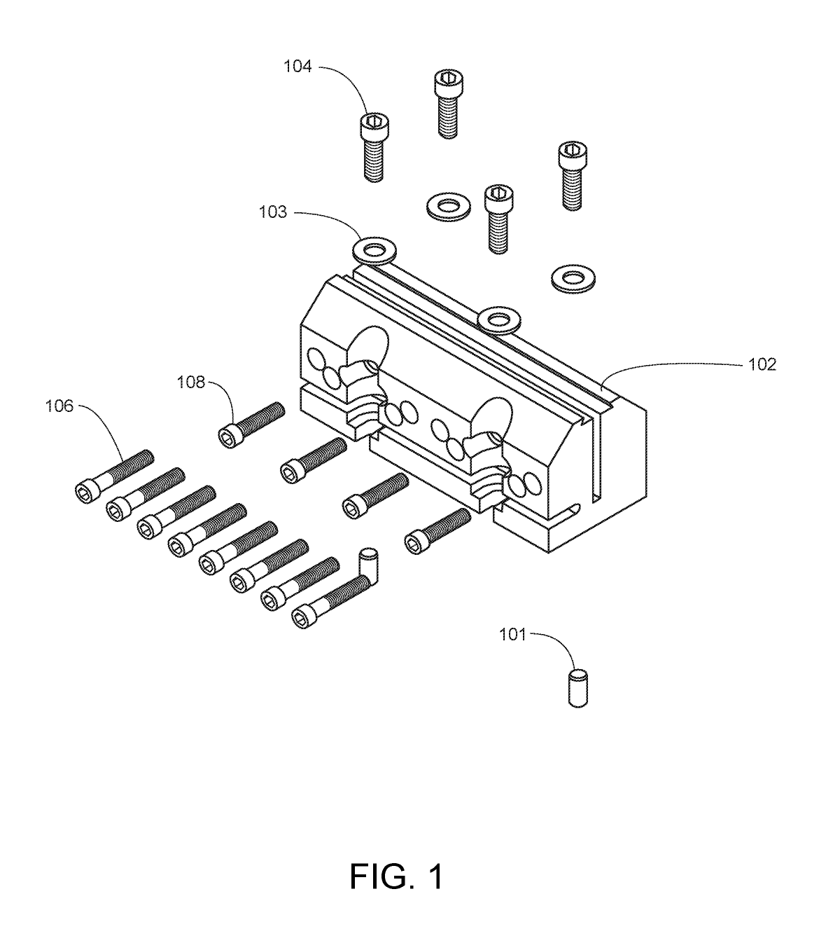

FIG. 1 Illustrates an exploded isometric view of the work holding fixture 102 as an assembly according to an exemplary embodiment of the invention. In addition to the work holding fixture 102, FIG. 1 also illustrates two dowel pins 101 (e.g., ¼″×½″ dowel pins), four washers 103 (e.g., ¼″ washers), and sixteen screws of three different types. There are four screws of a first type 104 (e.g., ¼-20×¾″ socket head screw), eight screws of a second type 106 (e.g., 10-32×1.25″ socket head screw), and four screws of a third type 108 (e.g., 10-32×⅞″ socket head screw). The work holding fixture 102 also includes a dovetail shape cut 120 that includes female characteristics, a parallel cut 130, and a perpendicular cut 140, Alternatively, different numbers and sizes of components may be used in other embodiments.

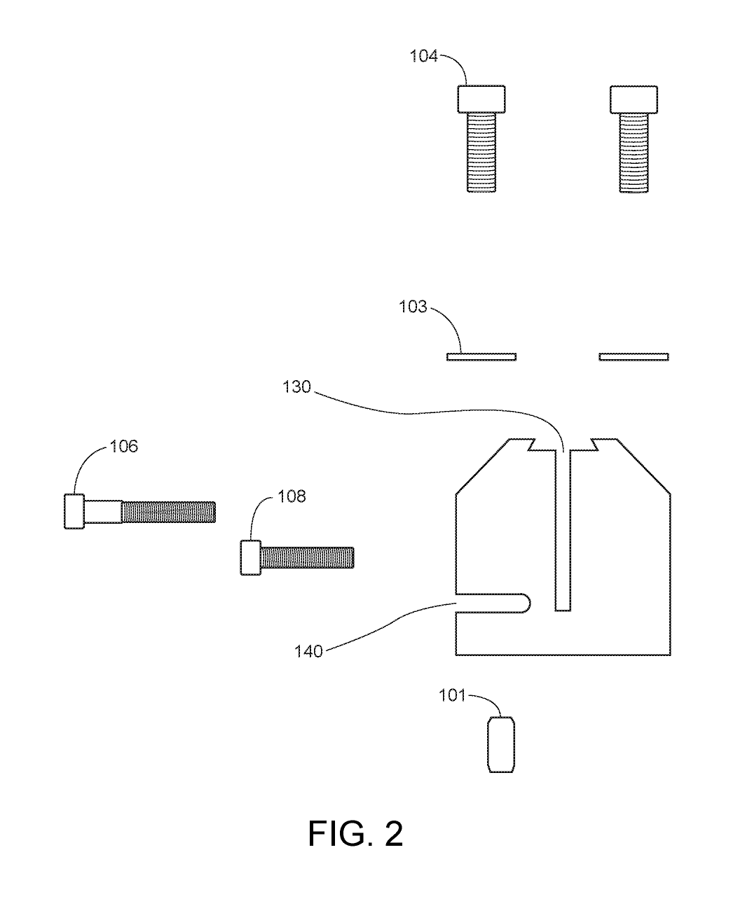

FIG. 2 Illustrates an exploded right side view of the work holding fixture 102 as an assembly according the exemplary embodiment of the invention. In addition to the work holding fixture 102, FIG. 2 also illustrates one of two dowel pins 101 of FIG. 1, two of the four washers 103 of FIG. 1, two of the four screws of a first type 104, one of the eight screws of a second type 106, and one of the four screws of a third type 108.

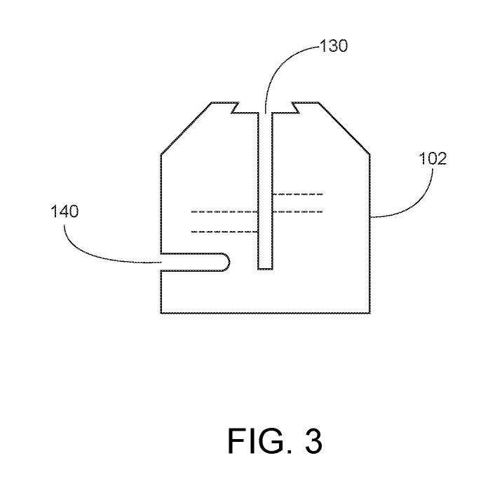

FIG. 3 Illustrates a front view of the work holding fixture 102 according to the exemplary embodiment of the invention.

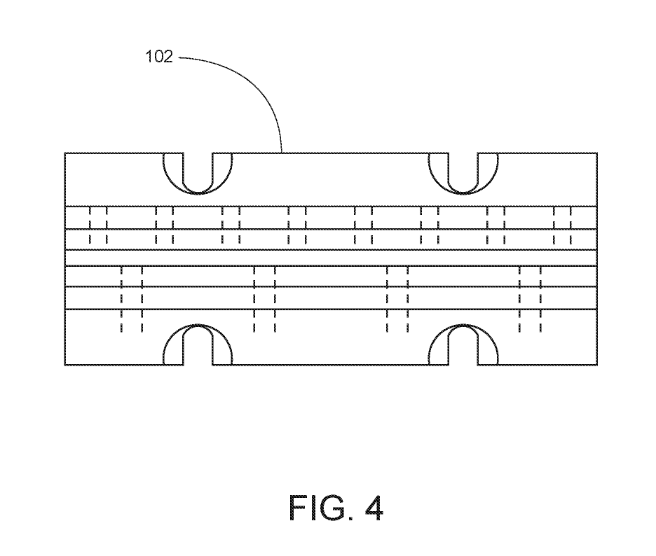

FIG. 4 Illustrates a top view of the work holding fixture 102 according to the exemplary embodiment of the invention.

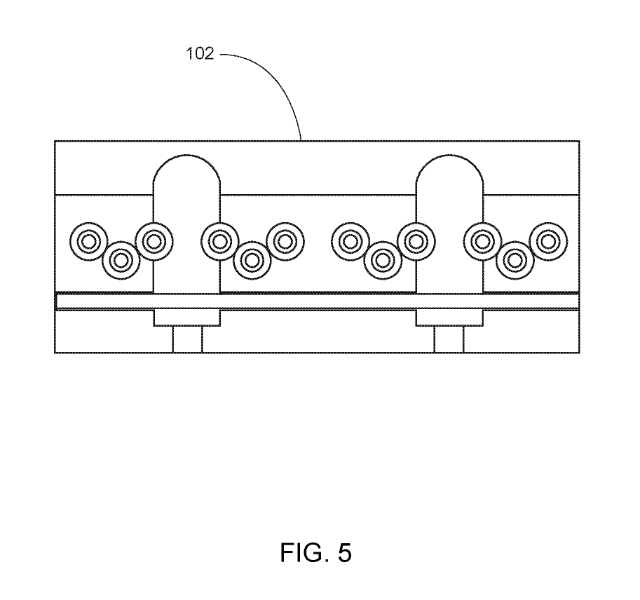

FIG. 5 Illustrates a right side view of the work holding fixture 102 according to the exemplary embodiment of the invention.

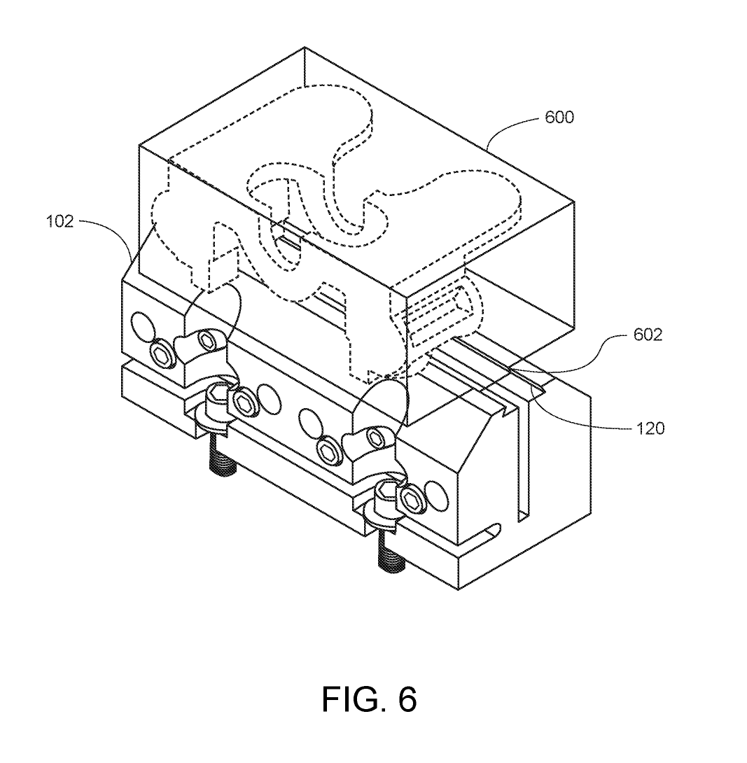

FIG. 6 Illustrates an isometric view of the work holding fixture 102 as an assembly clamping an exemplary component 600. The dovetail shape cut 120 that includes female characteristics engages the exemplary component 600 via its complementary male characteristics 602 to hold the exemplary component 600 in place.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A work holding fixture comprising:
a single blank of metal having a plurality of faces, and
a dovetail shape cut with female characteristics is located on one of the plurality of faces.

2. The work holding fixture of claim 1, wherein the dovetail shape cut is located on a top face of the single blank of metal.

3. The work holding fixture according to claim 1, further comprising:
a cut on the center of the single metal blank and perpendicular to the dovetail shape cut.

4. The work holding fixture according to claim 3, wherein the cut on the center of the single metal blank is ⅛ of an inch wide.

5. The work holding fixture according to claim 3, further comprising a second cut on a side of the single metal blank.

6. The work holding fixture according to claim 5, wherein the second cut is 5/32 of an inch wide.

7. The work holding fixture according to claim 5, further comprising:
a set of drilled and tapped holes for a plurality of screws.

8. The work holding fixture according to claim 5, further comprising:
a set of drilled and tapped holes for 10-32 screws.

9. The work holding fixture according to claim 7, further comprising:
a second set of drilled and tapped holes for a plurality of screws.

10. The work holding fixture according to claim 7, further comprising:
a second set of drilled and tapped holes for 10-32 screws.

11. The work holding fixture according to claim 9, further comprising:
two bores on each side of the fixture to hold the fixture using screws to attach a sub-plate which is clamped to a trunnion.

12. The work holding fixture according to claim 9, further comprising:
two ¼-20 c bores on each side of the fixture to hold the fixture using ¼-20 socket head screws to a sub-plate which is clamped to a trunnion.

13. The work holding fixture according to claim 11, further comprising:
precision blind holes on a bottom face of the fixture, and
two dowel pins are installed in the precision blind holes.

14. The work holding fixture according to claim 11, further comprising:
¼ inch precision blind holes on a bottom face of the fixture, and
two dowel pins are installed in the precision blind holes.

15. The work holding fixture according to claim 1, wherein the single blank of metal is a single blank of a soft metal.

16. The work holding fixture according to claim 1, wherein the single blank of metal is a single blank of aluminum.

17. A work holding fixture comprising:
a single blank of metal having a plurality of faces including a top face, a bottom face, and four side faces;
a dovetail shape cut with female characteristics is located on the top face;
a cut on the center of the single metal blank and perpendicular to the dovetail shape cut that is ⅛ of an inch wide;
a second cut on a side of the single metal blank that is 5/32 of an inch wide;
a set of drilled and tapped holes for 10-32 screws;
a second set of drilled and tapped holes for 10-32 screws;
two ¼-20 c bores on each side of the fixture to hold the fixture using ¼-20 socket head screws to a sub-plate which is clamped to a trunnion;
¼ inch precision blind holes on a bottom face of the fixture; and
two dowel pins are in the precision blind holes.

18. The work holding fixture according to claim 1, wherein the single blank of metal is a single blank of a soft metal.

19. The work holding fixture according to claim 1, wherein the single blank of metal is a single blank of aluminum.
